(19) United States
(12) Patent Application Publication
(10) Pub. No.: US 2015/0283409 A1
(43) Pub. Date: Oct. 8, 2015

(54) Oxygen Augmented Powered Air Purifying Respirator

(71) Applicant: C&B Technology LLC, Chesapeake, VA (US)

(72) Inventor: David A. Buck, Chesapeake, VA (US)

(73) Assignee: C&B Technology LLC, Chesapeake, VA (US)

(21) Appl. No.: 14/243,534

(22) Filed: Apr. 2, 2014

(51) Int. Cl. A62B 7/02; A62B 23/02; A62B 9/02; A62B 18/02; A62B 7/10; A62B 7/12

(52) U.S. Cl. CPC A62B 7/02; A62B 7/10; A62B 7/12; A62B 9/02; A62B 18/02; A62B 23/02

(57) ABSTRACT

A hybrid self-contained breathing apparatus having an oxygen augmentation system for delivering oxygen to a stream of monitored ambient air.

### FIELD OF THE INVENTION

This specification relates to a device and system providing breathable air to a user under extreme conditions, such as chemical, biological, radiological, nuclear and/or low oxygen environments. More particularly, the present invention relates to a device and system to provide respiratory protection by allowing the user in an extreme environment to utilize one of several different configurations to receive breathable air.

### BACKGROUND

Current respiratory protection systems suffer from the use of heavy and unwieldy components and configurations that are impractical. These systems are not intended for combat operations, heavy exertion or extended duration exposure, and do not operate effectively in a chemical, biological, radiological, nuclear, or low oxygen environment. Current technology, whether using the standard SCBA or the modified self-contained system with supplemental air provision, are fundamentally inadequate for either civilian/firefighting or combat applications. In the case of the standard SCBA, the equipment is cumbersome, heavy and requires the user to begin consumption of the limited air source the moment the user dons the equipment. This limits the range and time available in the undesirable and/or unsuitable environment. In the case of the SCBA coupled with an augmented pressurized air system, although enhanced over single purposed SCBA systems, in order for augmented pressurized air systems to be of any significant benefit it must be used in an environment having adequate oxygen levels (19%+) and ambient air suitable for filtration.

A hybrid breathing system is disclosed in U.S. patent application Ser. No. 13/106,609, incorporated herein by reference in its entirety, which offers a lighter and more compact system than traditional SCBA's or prior-art hybrid systems. This light weight system provides for greater flexibility for access to confined spaces and less fatiguing to use in high stress environments. All hybrid systems do provide for significantly longer periods within certain environments, due to the user not consuming the compressed air supply immediately upon donning the equipment. Additionally, the time of hybrid systems is extended if the user is in a normal O2 and filterable environment. Using current Hybrid breathing systems, the user does not commence consumption of the compressed air reserve until the wearer enters a hostile environment that has oxygen levels below a preset value, for example below normal ambient levels or has an environment that will not effectively be removed by the filters employed. At that point the operator is subject to the time constraints provided by the compressed bottle supply similar to that of the SCBA. A system and method of use is needed to extend operating time in an oxygen deficient environment beyond prior-art breathing systems.

### SUMMARY

This specification describes technologies relating to an oxygen augmented powered air purifying respirator (OAPAPR). In some example embodiments, a metered oxygen supply is provided as well as an integrated emergency life support system.

Embodiments of the present invention significantly extent time an operator can remain in a low oxygen environment. The duration is dictated by the amount of oxygen held in the “Supplemental Oxygen Augmentation Cylinder” and the ambient level of oxygen within the environment. The oxygen delta between 21% and the ambient level within the space will limit the safe time constraint and dictate transitioning to the compressed air reserve.

The embodiment of this invention discloses a reliable and flexible respiratory protection system intended to meet all areas of operational need including; civilian, fire and combat. This new hybrid system significantly exceeds the capabilities of presently available SCBA and PAPR systems in oxygen deficient environments and succeeds in a CBRN environment. Embodiments of the present invention provide improved safety features over prior art breathing systems by extending operating time in an oxygen deficient environment and providing an emergency supply of oxygen to facilitate egress.

The disclosed embodiment employs modular geometry designed to allow the user, to select from several different respiratory protection format and configurations and is equipped with numerous additional safety and life support controls. This modularity allows the disclosed embodiment to meet the unique demands of specific missions or operational environments without the high maintenance cost or expense of retrofitting any current system

According to the disclosed embodiments a self-contained integrated life-support device is provided that allows an operator to select multiple modes of respiratory protection. These modes include one for a self-contained breathing apparatus (SCBC). Another mode embodies a powered air purifying respirator (PAPR). Another mode may be one of an air purifying respirator (APR). Another mode may be one for a supply air respirator (SAR). Another mode may be the oxygen (augmentation system of the powered or oxygen) augmentation powered air purifying respirator system with a metered oxygen supply (OAPAPR).

Embodiments of this present invention are directed to a breathing apparatus comprising; one or more contained air cylinders connected to a supply manifold plus one or more cylinders containing pure oxygen or an oxygen rich blend, (the concentration of oxygen maybe varied within the augmentation cylinder/tank from 21% to 100% depending on the selected application and operational specifications of the system) connected to a manifold or to separate manifolds, mechanically connected to the air/oxygen cylinder manifold; a contained air supply hose; an oxygen supply hose connected to a control solenoid connected to a filtered air manifold: one or more air filters is connected to a filtered air manifold; a blower motor connected to the filtered air manifold; a filtered air supplies hose connected to the filter air manifolds; a series of sensors connected to filter manifold connected to a processor: a control processor electrically connected to a solenoid mounted on the filter manifold: a filtered air/oxygen enriched manifold connected the filtered air supply hose and the filtered air supply hose for delivery of filtered air supply, an oxygen augmented air supply, or power filtered air supply: a compressed air line connected to a second stage regulator: the air filter supply hose and the second stage regulator connected to a breathing control selector valve: a control selector valve connected to the mask; and control programming or logic sequencing to control the operation and monitoring functions of the device.

In some embodiments, the oxygen augmentation powered air purifying respirator system (OAPARP) incorporates a metered oxygen supply regulator, an oxygen augmentation cylinder, a minimum of 2 oxygen and ambient air sensors, and constitutes a revolutionary new design. The ability of the OAPARP to augment ambient filtered air within the filtered air manifold provides a distinct new source of breathable air, different and superior to any other SCBA or PAPR system.

In another embodiment a breathing device comprises: a pressurized air manifold with one or more pressurized cylinders of compressed air and one or more pressurized cylinders containing an oxygen blend; a pressurized air supply hose, and a single oxygen supply hose: a single or multiple manifold system depending on the selection of materials the manifolds are to be made from: connected to one or more of the cylinders: two pressurized air supply hoses connected to first stage regulators: a first stage Oxygen regulator connected to the oxygen manifold: connected to an oxygen metering solenoid mounted on the bottom of the filtered air manifold: a 1st stage compressed air regulator connected to the compressed air manifold: connected to the second stage regulator: a filter air module comprised of one or more air filters, a filtered air supply hose, connected to a regulator connected to the air manifold, and a filtered air manifold connected to one or more filtration cartridges and the filtered air supply's, a powered air module comprising a blower motor connected to the filtered air manifold and an air supply assembly for delivery of pressurized air, filtered air and oxygen enriched air to a user comprising a regulator connected to the pressurized air supply hose and a filtered air supplies connection.

In one example embodiment a breathing apparatus and automated control system provides for the controlled supplementation of pure oxygen or oxygen enriched compressed gas into the air path created by the filter air manifold. This embodiment supplements the air supply, within the filter air manifold, with oxygen augmentation. This augmentation of oxygen enriched gas is controlled by sensors located in the ambient air near the filter inlets to the air manifold. A second sensor will be located at the outlet from the PAPR motor, providing suitable information for oxygen delta reading between the ambient air and the user's source. The control system monitors and controls oxygen augmentation as is necessary to support life, maximize the oxygen augmentation supply and optimize the operator time within a hostile environment. Unlike the prior iterations, if in fact a user enters a space that has a low oxygen content the user must immediately transition over to the compressed air bottles. In the oxygen augmentation hybrid that will be unnecessary. This is critical since the vast majority of the environments that the current PAPR systems are used are in low oxygen content environments. In these environments, the system user must immediately transition to the compressed air cylinders. Whereas in the case of the SCBA, the user is immediately connected directly to the compressed air supply, severely limiting the useable operating time to approximately 45 minutes. The time limit attributed to a PAPR system is extended only by the time that and operator is in an acceptable ambient oxygen atmosphere. Once the operator enters a space with a low ambient oxygen level, the operator time is the same as a standard SCBA or less.

Example embodiments of the present invention comprise a breathing apparatus including: one or more contained air cylinders connected to a supply manifold; one or more oxygen augmentation cylinders connected to the supply manifold; a first supply hose; one or more filters connected to a filter air manifold; a filtered air/oxygen augmented supply hose connected to the filtered air manifold; a compressed air supply hose connected to both the contained air supply hose and the filtered air supply hose for delivery of pressurized contained air, filtered air, powered filtered air or oxygen augmented air.

Example embodiments of the present invention may further comprise one or more of the following features. The pressurized compressed air is supplied on demand if the filtered/oxygen augmented air supply is reduced. A regulator is connected to the contained air and oxygen augmentation supply sources. Two high-pressure regulators are in communication with the supply manifold. Two high-pressure assemblies comprising a high pressure input connection and a high pressure output connection wherein the high-pressure assemblies are in communication with the supply manifold. Self-contained air is supplied to a second air supply assembly through the high-pressure assembly. Oxygen augmentation is supplied to the pressurized air manifold. The contained air cylinders are charged with high-pressure air through the high-pressure assembly. The contained oxygen cylinders are charged through a high pressure port located in the manifold adjacent to the oxygen cylinder. The air supply assembly is a sealable mask. At least one of the cylinders contains an oxygen enriched gas and at least one cylinder contains compressed air.

Another example embodiment of the present invention comprises a modular breathing apparatus including a self-contained air module comprising one or more pressurized cylinders, a pressurized air supply hose, and a manifold connected to one or more cylinders and the pressurized air supply hose; a filtered air module comprising one or more air filtration cartridges, a filtered air supply hose, a filtered air manifold connected to the one or more filtration cartridge, and a filtered air supply hose a powered air module comprising a blower motor connected to a filter air supply; an oxygen augmented assembly comprising one or, more compressed oxygen augmentation cylinders connected to a manifold, a regulated solenoid valve feeding the filter manifold prior to the pressurized blower, a pressurized air supply hose, and an Electronic Logic Control module; an air supply assembly for delivery of pressurized air in filtered air to a user comprising a regulator connected to the pressurized air supply hose and a filter air supply connection. A split manifold may be provided between the compressed gas and oxygen augmentation supply wherein the oxygen flow and compressed air flow are fluidly isolated. The split manifold may be of a single material or different materials more suitable for the gas flowing through the manifold.

Still another embodiment of the present invention comprises a breathing apparatus including a continuous oxygen sensor; an oxygen supply; and control logic for delivering oxygen from the oxygen supply in sufficient quantity to provide breathable air to a user having an oxygen concentration of 20% to 22% oxygen.

Embodiments of the present invention may further comprise one or more of the following features. A blower and filter system for delivering pressurized air to a user. The oxygen is supplied to air received from the blower and filter system. The control logic causes compressed air to be delivered to the user when the oxygen supply falls below a preset level.

Further embodiments of the present system may comprise a method of controlling a breathing apparatus including the steps of: continuously monitoring oxygen levels in air supplied to a user; causing oxygen or oxygen enriched air from an oxygen supply to be delivered to air supplied to a user when the monitored oxygen levels fall below a predetermined value; monitoring the supply level of oxygen or oxygen enriched air; and causing compressed air to be delivered to a user when the supply level of oxygen or oxygen enriched air falls below a predetermined level. The air supplied to a user is ambient air from a blower and filtration system. Oxygen levels are monitored in the ambient air and in the air delivered from the blower and filtration system.

Particular embodiments of the subject matter described in this specification can be implemented so as to realize one or more of the following advantages: Less weight and smaller cross-sectional area; longer effective operating time the operational zone; increased versatility in operating modes and operational choices for the delivery of breathable air; multi-use oxygen supply (e.g., oxygen is available for breathing, medical supply, cutting tools or other auxiliary systems); wearable in front or back, and operational when removed to facilitate driving, operation of machinery or other operational needs; the compressed air supply is not used until needed once in or just before entering a hazardous environment; facilitates operations and extended operations in a low oxygen environment; greater versatility in operational choices relating to the mode of delivering breathable air to the user; enhanced environmental and operational safety and warning systems; logic and control features that automatically modulate between air sources to assure safety and longevity.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a front view of an exemplary embodiment of the present invention.

FIG. 2 is back view of an exemplary embodiment of the present invention.

FIGS. 3 and 3A are exploded views of the manifold of an embodiment of the present invention.

FIG. 4 is a diagram of an electrical system of an embodiment of the present invention.

FIG. 5 is a flow chart of an embodiment of the present invention including a basic logic control diagram.

FIG. 6 is an embodiment of the present invention with the blower motor at the top of the center assembly.

FIG. 7 is an embodiment of the present invention with a blower motor at the top of the center assembly without filter attachments.

Like reference numbers and designations in the various drawings indicate like elements unless specifically stated otherwise.

### DETAILED DESCRIPTION

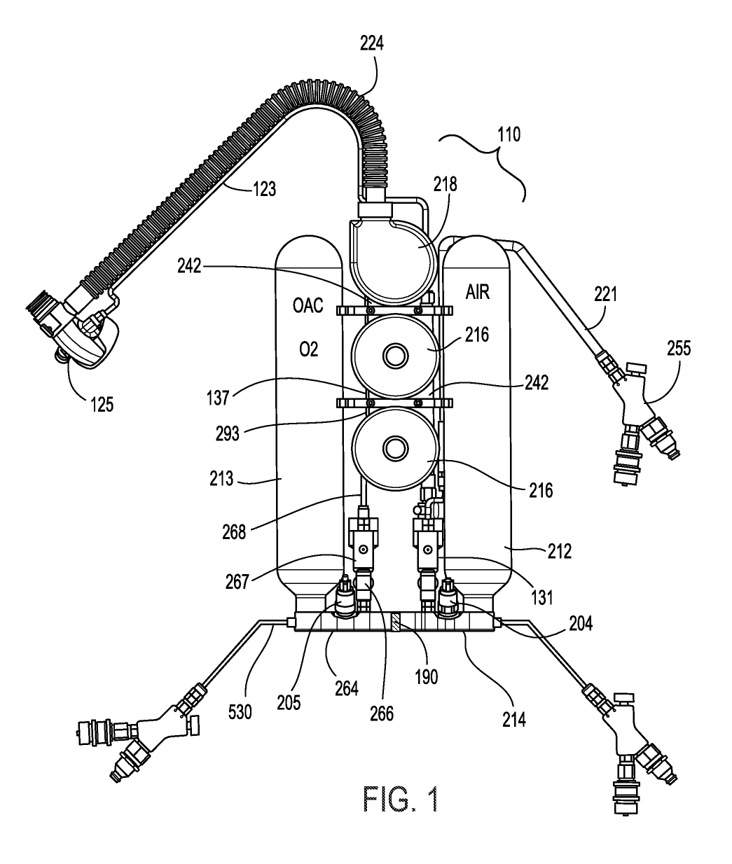

As shown in FIG. 1, an exemplary embodiment of the present invention includes a breathing apparatus comprising an Oxygen Augmentation Cylinder (OAC) 113, a shut off valve 266, regulator 267 and a pressure line 268 leading up along the side of the air filter manifold 242. Cylinder 112 on the right of the air supply manifold would be compressed air. In some implementations of the present invention the manifold represented by 114 is not a contiguous pathway. Blockage 190 indicates a discontinuity of path within the manifold. The manifold 114 may be made of one material forming a homogeneous block if that material is compatible with both high concentrations of oxygen and compressed air. Such a material could be stainless steel, but the composition of the manifold is not solely limited to that material. In another embodiment of this design the manifold 114 would be compromised of 2 separate manifolds 264 and 214. These separate manifolds would be made from dissimilar materials compatible with their respective gas streams and mechanically joined at location 190. Typical materials that would be considered are titanium on the compressed air side of the manifold 264 and stainless steel on the oxygen side 214. The choices of alternative materials for the manufacture of such manifolds should not be limited to only these choices, but are indicative of the types of materials that would be chosen. The reason for the selection of alternative materials in the makeup of the manifold 114 would be to attain, for example, a reduction in weight of the manifold. The inventor may substitute other compatible materials in future iterations looking to accomplish other objectives. Pressure sensor 205 monitors low-pressure in the OAC cylinder 113. Pressure sensor 204 monitors low-pressure in the compressed air cylinder 112. Regulator 131 is the 1st stage regulator providing air to the 2nd stage regulator 125 through hose 123. Regulator 267 provides oxygen to the oxygen solenoid 269 (not shown) which supplies air through hose 137 to the filtered air manifold 242.

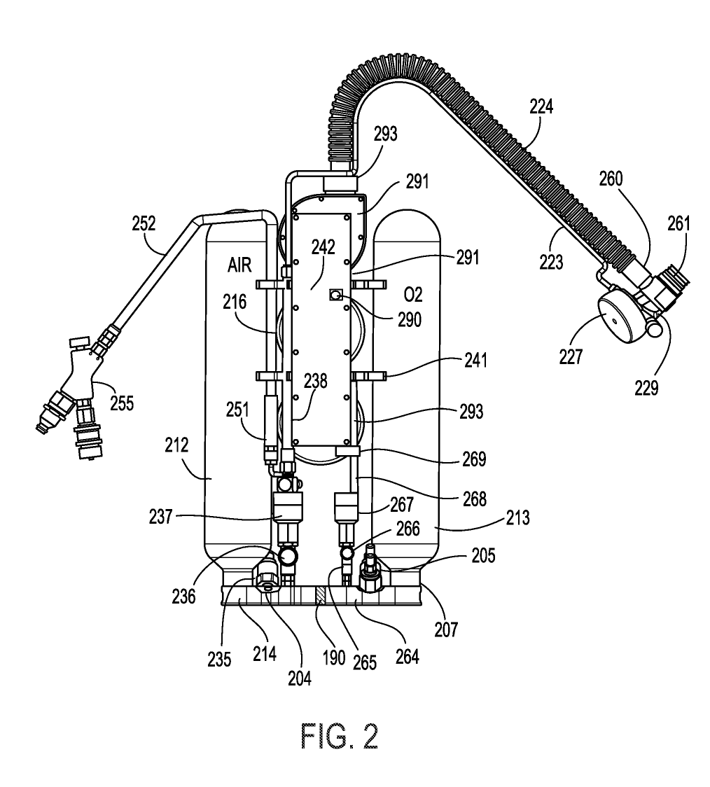

FIG. 2 is a back view of an exemplary embodiment of the present invention. Cylinder 213 located to the right of the air supply manifold would be an OAC cylinder. Cylinder 212 located to the left of the air supply manifold would be a compressed air cylinder. Located just to the left of the OAC cylinder 213 would be a high pressure supply line 265, a shut off valve 266; an oxygen supply regulator 267; an oxygen augmentation supply hose 268; an oxygen supply control solenoid 269; an oxygen augmentation supply line 293; and an oxygen augmentation supply nozzle 291. This oxygen shut off 266, supply line 265 and regulator 267 would be connected to a solenoid 269 located at the bottom of the air filter manifold 242. This solenoid 269 would have a supply line 293 terminating at the top side 291 of the air filter manifold 242 just above the entrance of the highest air filter into the manifold. This hose connection 291 would allow for the addition of high concentration oxygen (21% to 100%) into the air manifold 242 above the oxygen content sensor 290. Just above the inlet for the oxygen augmentation line 291 into the manifold 242, and below the suction port of the PAPR blower 218, will be located a sensor 293 designed to monitor oxygen level in the air line 224 and by establishing a delta level between ambient and air delivery. This information is delivered to the oxygen logic controller (OLC) which translates the oxygen level delta between ambient and the desired level and automatically injects an oxygen enriched burst from the OAC into the manifold 242 controlling the oxygen level (% O2 content) within the manifold 242 to acceptable breathing concentration.

Manifold 214 discharges high-pressurized air into the air manifold 214 connected to air port 235, which is connected to on/off valve 236, high-pressure reducer 237 and low-pressure interface hose 238. Low-pressure interface hose 238 can also be in connection with high-pressure regulator 251 and high-pressure hose assembly 252, which in turn are connected to high pressure console assembly 255. Low-pressure interface hose 238 is connected to low-pressure air hose 223 and low-pressure, 2nd stage demand regulator 227. In embodiments, low-pressure air supplies hose 223 is helically wound about filtered air supply hose 224.

In some embodiments of the invention, low-pressure interface hose 238 can run along or be secured to air filter mounting bracket 241 and high-pressure hose assembly 252 can also be secured to air filter mounting bracket 241. Air filter mounting bracket 241 and air filter mounting manifold 242 can provide structural support to the fully assembled breathing apparatus 210. One of more air filters 216 attached to air filter mounting manifold 242 via air filter connection 217 (not shown). When a blower motor or air filter is not connected to connection 217, the connection can be secured with a filter Connection 219, (not shown) in order to preserve a closed system. It will be appreciated that any number of arrangements having one or more filters with or without the blower motor can be assembled using the filter air manifold and various air filter connections. For example three filter cartridges and the blower motor can be connected. Two filter cartridges and the blower motor can be connected. One filter cartridge and the blower motor can be connected. Three filter cartridges can be connected with no blower motor attached. The blower motor can be attached without any filter cartridges.

Filtered/augmented air supply hose 224 can connect directly to motor blower 218, which in turn draws air from the filtered air manifold 242 in these embodiments, the filtered/augmented air supply hose 224 can connect directly to the filter air manifold 242. Filtered/augmented air hose assembly 229 is attached by a bond hose connection or other standard hose connections. Air supply assembly 229 includes low-pressure, 2nd stage demand regulator 227, filtered/augmented air supply hose connection 260, and mask connection 261. Mass connection 261 can be a quick connection, such as the NATO standard mask quick connection.

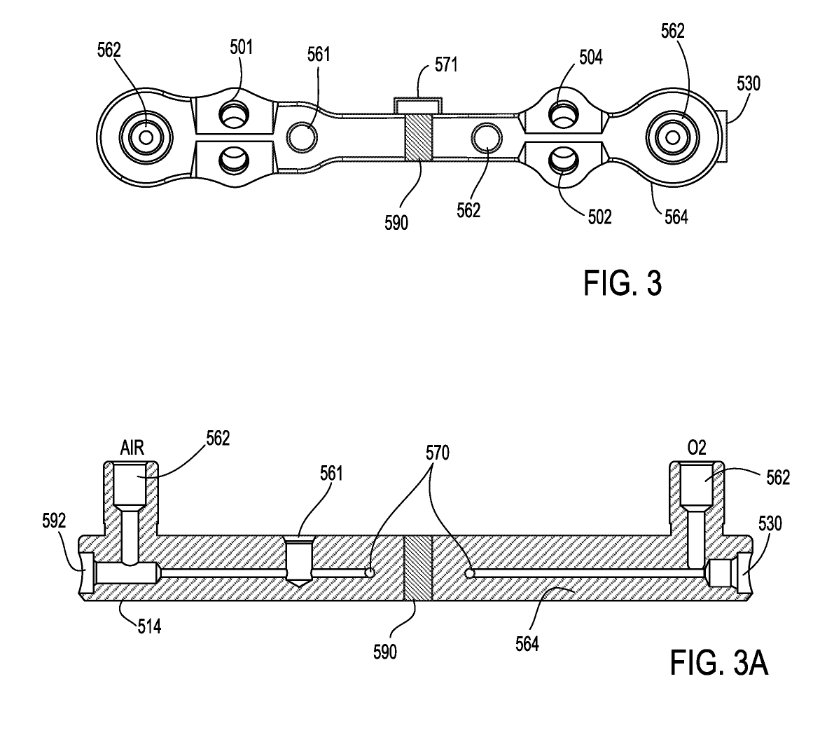

FIG. 3 is a blowup of the manifold of an embodiment of the present invention in its simplest form. The manifold depicted in FIG. 3A is a two cylinder system, with all 3 compressed air cylinder and OAC connected to a single manifold having 2 separate and distinct modules 514 and 564. Each manifold is provided with its separate outlet, compressed air outlet 561 and oxygen outlet 562. Connection 590 represents a mechanical connection between the 2 separate manifolds and would be employed when dissimilar metals were used in the construction of the 2 separate manifolds 514 and 564. FIG. 3 and FIG. 3A represent a 2 tank system but in other embodiments of this application additional oxygen augmentation cylinders and compressed air bottles could be employed in a larger monolithic manifold made from materials compatible to both air and oxygen or in separated manifolds. The most common iteration of this patent would probably be the design represented, however one compressed air bottle, one compressed OAC design will be offered as depicted in the manifold displayed there can be no co-mingling of gases within the manifold. However, there may be provided in some embodiments, a system of manual jumper ports 570 and a jumper feed 571 which would allow for manual connection of the 2 sides of the manifold. This embodiment/option is considered to be highly unusual due to the concerns of cross-contamination of the oxygen supply side of the manifold 564, but is mentioned to indicate the infinite possible design options this system affords the user. FIG. 3A envisions in this new embodiment one of the two designs. If the manifold is to be made from one material, it must be a compatible with the dispensing of oxygen and compressed air such as stainless steel. Other materials are suitable and should be considered covered by this embodiment if they meet the compatibility criteria. The manifold, as it would be manufactured, would have to have a noncontiguous path between the outlets of the air tanks and the OAC. Outlet port 504 is provided for a regulator and shut off valve to control the supply of oxygen to the system. Outlet port 502 is provided for installation of a pressure sensor monitoring the status of the oxygen augmentation bottle pressure. Outlet port 501 is provided for a regulator and shut off valve to control the supply of compressed air to the system. Outlet port 503 is provided for installation of a pressure sensor monitoring the status of the compressed air bottle. Outlet ports 562 located on manifold 514 and 564 are provided for the attachment of air and oxygen augmentation bottles respectively. The embodiment of this combined manifold 514 and 564 is used for the purpose of controlling or reducing weight. Stainless steel and other compatible materials with both oxygen and compressed air can be very heavy. Given that one of the essences of this patent and invention is its light weight, it may be envisioned to have a manifold that would be ⅔ titanium or some other metal compatible and durable enough to withstand a pressure of 6000 psi with compressed air medium. While the other ⅓ of the manifold would be made from a material compatible with and durable enough to a standard 6000 psi of compressed oxygen. These two independent materials would be then join together, mechanically, forming a single lighter weight manifold to be used with this embodiment. A potential additional embodiment of this manifold would be to make it from one homogeneous material that would be compatible with both oxygen and compressed air. Such a material would be stainless steel but others could be envisioned. This manifold however must not provide for a common pathway between the compressed air and oxygen supplies. Another potential embodiment of the manifold system will have 2 separate and distinct manifolds, one being used in conjunction with the OAC the other for the compressed air. These manifolds would however still interact with the main system in the same way.

Charging of the compressed air cylinder would be accomplished through the air charging manifold 255 and charging line 252 entering through port 561. Charging of the oxygen augmentation cylinder would be accomplished through a charging fitting located at port 530. FIG. 1 illustrates an embodiment wherein three charging/emergency X valve whips 255 are shown. These whips, provide the ability to monitor the actual pressure within each tank, a method by which to provide emergency air or oxygen to an associate similarly equipped, to act as the charging port for the respective cylinders and as an coupling system for creating an interconnection between the two cylinders in an emergency situation, and various other connections between cylinders, different systems, and recharging stations. The illustration in FIG. 1 shows three X valve whips in various locations on the breathing apparatus. In some embodiments, one, two or three or more X valve whips can be incorporated. An X-valve whip can be dedicated to the oxygen cylinder(s) and oxygen side of the manifold. An X-valve whip can be dedicated to the compressed air cylinder(s) and the compressed air side of the manifold. An X-valve whip can be configured to be operable with both the oxygen and compressed air supplies.

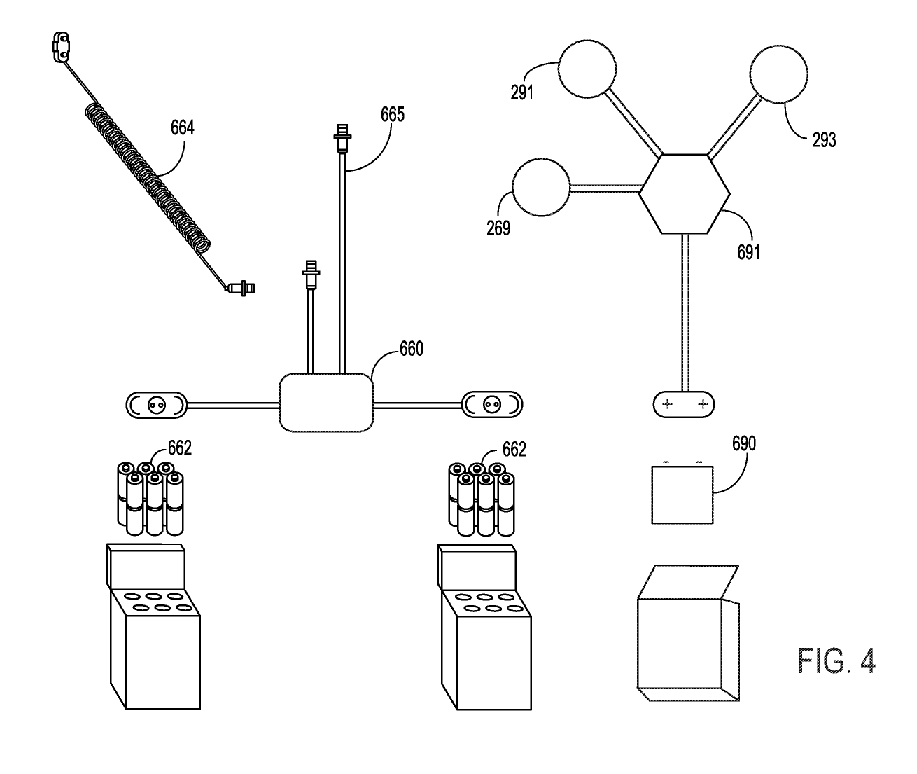

FIG. 4 is a diagram of an example electrical system of an embodiment of the present invention that includes an additional source of electrical power 690. This additional power source feeds the processors and the software package 691, which is designed to monitor through sensors 291 and 293, operate the oxygen augmentation system through solenoid 269, and alarm packages (not shown). Other sensors, such as carbon monoxide and filter failure indicators (not shown), can be supplied to assure system integrity and operator safety. The second power source 662 is designed to support the continuous operation of a pressurized air blower 665 and 664. In some embodiments of the invention, a common power source can be used for all electrical demands. The system will monitor and control oxygen levels within the air supply manifold, sense pressures 204 and 205 within the various cylinders will alarm on low-pressure and verify normal operating pressure, monitor electrical circuit status and alarm, monitor blower status and provide for an over view of system functionality. In future embodiments it is envisioned that in the stream gas analysis equipment will be included within the air supply manifold monitoring the overall condition of the source of air supply weather on ambient air filtration or in oxygen augmentation mode.

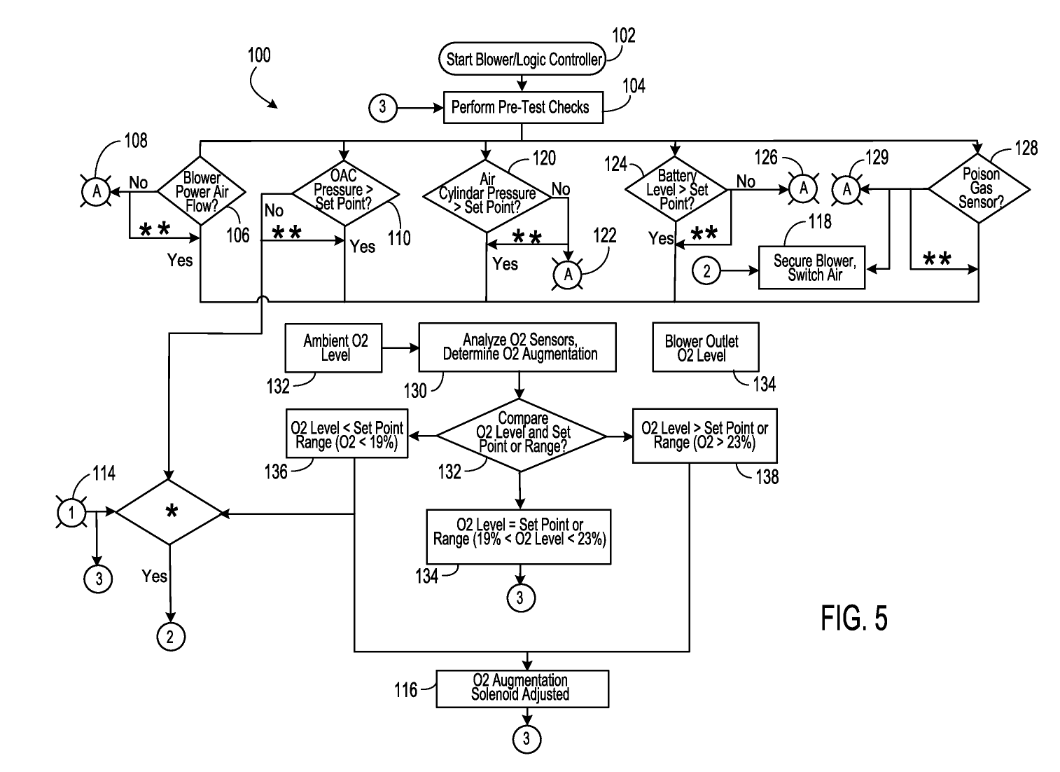

FIG. 5, an exemplary control algorithm comprises performance of one or more pre-test checks 104 including blower power air flow 106, OAC pressure set point 110, air cylinder pressure set point 120, battery level 124, and poison gas sensor 128; as well as Oxygen sensor 130 and oxygen augmentation 132.

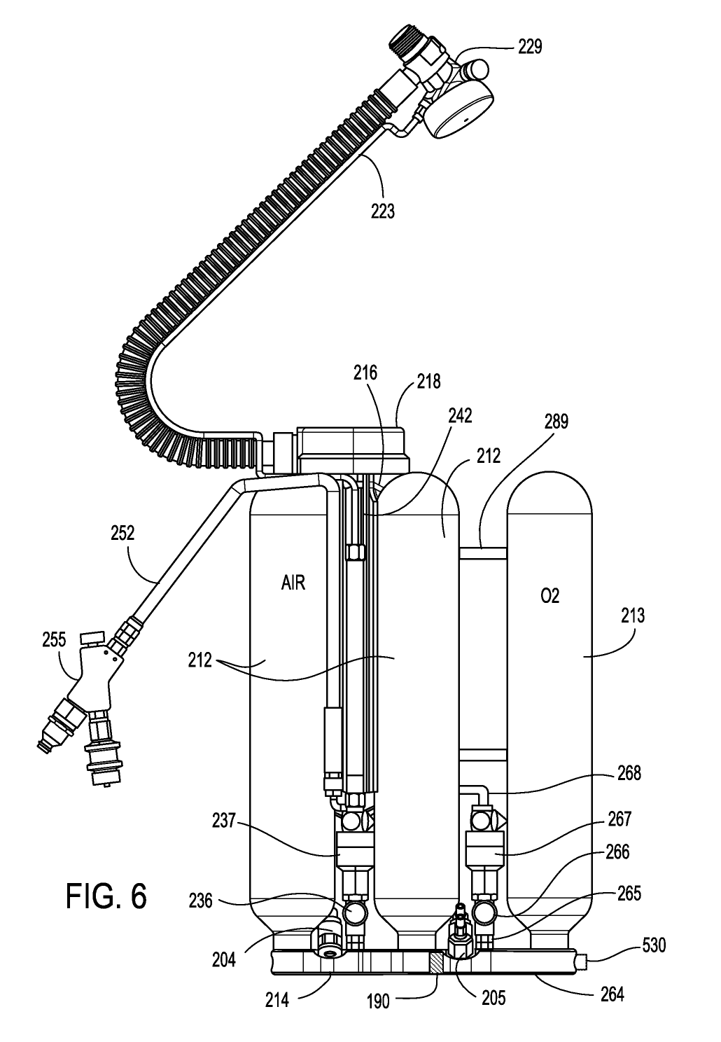

FIG. 6 is an embodiment of the present invention with the blower motor 218 at the top of the center assembly of the air pressure manifold fortune 242. In this embodiment, the cylinder 213 would represent the oxygen tank in this scenario. The shut off valve 266, pressure sensor 205, regular valve 267, depict that of the oxygen line. The line 268 would feed a solenoid located at the bottom of the pressurized air manifold 242. The oxygen augmentation line 268 would lead to an entry point along the side of the air pressure manifold 242 (not shown) entering above the highest filter 216 and below the entrance to the pressurized air blower 218. In this three tank embodiment, the manifold 214 would have located between the two compressed air cylinders 212 a shut off valve 236, and line 252 proceeding to FIG. 255 supplied for air charging. In addition a second line 223 would proceed to air inlet on the second stage 229. This then would allow normal operation of the compressed air tanks 212, proper filling of the compressed air tanks and operation in the air augmentation mode. Additionally there would be a pressure indicating switch 204 located between the two compressed air tanks and a similar pressure sensor 205 located at the oxygen cylinder 213 and the regulators shut off valve 266. It must be noted that this manifold embodiment, as depicted, would have a common pathway of air supply between compressed air cylinders 212, but would be segregated from the oxygen manifold 264 by either a physical block 190 or the manifold would not be made of a continuous material. This manifold would either have to be of one compatible material similar to stainless steel with a break in continuity of the air path 190. The other possible embodiment would be of two dissimilar materials providing for an ability to reduce the weight of the manifold itself, typical alternatives would be a titanium manifold 214 for the compressed gas cylinders and a stainless steel manifold 264 section for the oxygen inlet. It is envisioned that other materials could be used in place of the ones mentioned in this embodiment accomplishing the same net overall effect, but serving other purposes.

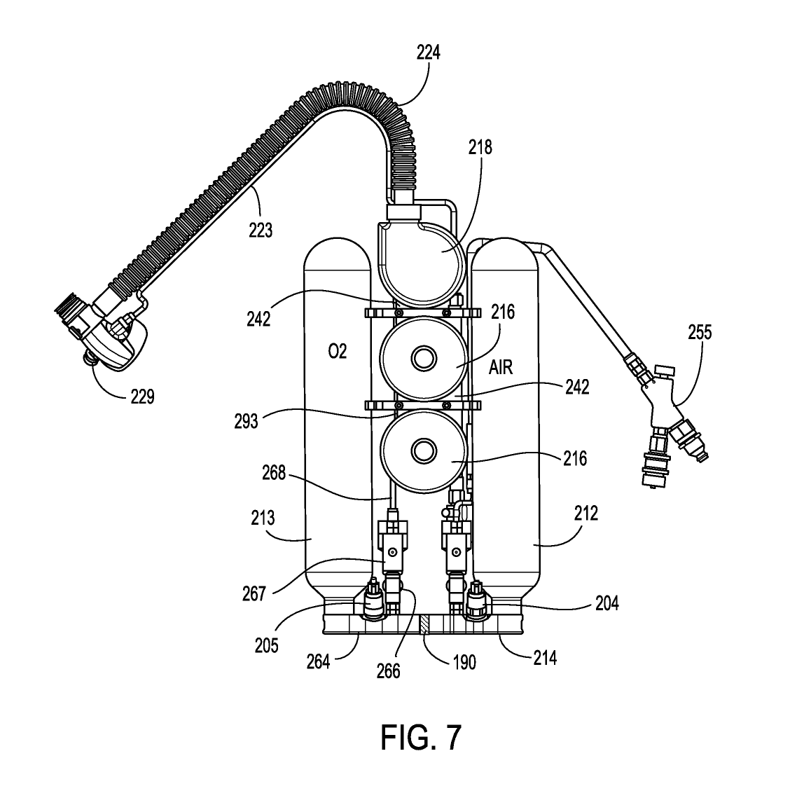

FIG. 7 is an embodiment of the present invention with the blower motor 218 at the top of the center air filter manifold 242 assembly with filter 216 attachments. Under the new embodiment of this patent cylinder 213 would contain oxygen, while cylinder 212 would be a compressed air cylinder. Adjacent to cylinder 213 is located a pressure sensor 205 which would monitor the pressure within the oxygen tank 213. Adjacent to sensor 205, is a shut off valve 266, regulator 267 and hose 268 connecting to an electrically controlled solenoid (not shown), operated by proprietary software. The outlet of this solenoid will be equipped with suitable hose 293, designed to be durable and compatible with oxygen, and would proceed to the pressurized filtered air manifold 242, entering the manifold just above the top filter 216 and below the air inlet for the blower motor item 218. Not depicted would be the oxygen control sensor located just below the inlet to the pressurized air blower item 218. The depicted manifold, being a single material design, would be of a compatible material for both compressed air and oxygen with a separated air path for each gas, or a multiple material design may be employed with segmented manifolds being made from gas compatible materials and mechanically connected.

Referring again to FIG. 1, a compact low-profile multiuse breathing apparatus 110 comprises two compressed gas cylinders 212 and 213, a compressed air and oxygen cylinder respectively, connected to a segmented manifold 214 and 264, air filters 216, blower motor 218 high-pressure console assembly 255, high-pressure compressed air hose 221, low-pressure air supply hose 123 and low pressure blower hose 224, oxygen supply hose 293, and regulator filter air supply assembly 125.

In one example implementation of the present invention, breathing apparatus 110 supplies filtered ambient air, through the filters 116 into the air supply manifold 242.

The ambient air is drawn by either normal respiration through the filters or through the suction of the pressurized air blower 218. As the air is pulled through the manifold 242 it encounters the oxygen level sensor 290 and is analyzed for oxygen content. The oxygen level sensor 290 can be adjusted for numerous operating levels but is envisioned, in the current iteration at 2% below ambient or 19% oxygen content. If oxygen levels are, at a level below the preset, the proprietary control software 691 will trigger a burst of oxygen through hose 294, through the oxygen control solenoid 269, provide by the first stage oxygen regulator 267, flowing through shut off valve 266, from 264. Oxygen sensor 290 continuously monitors the level of oxygen within the air pressure manifold 242 under all operating situation whether natural draft or pressurized blower. Under normal oxygen level, in excess of 21%, this self-contained breathing system can operate in either a purified respirator mode or a powered air purification respirator mode without activation of the oxygen augmentation system. Under conditions where oxygen levels are below or at 19% the oxygen augmentation system will automatically elevate and control the oxygen level within the filter manifold 242 providing appropriate and safe air to the user. In addition, if the oxygen cylinder 213 is exhausted an alarm will be sounded. In addition, if the oxygen cylinder is empty and the user is in a low oxygen environment the supply will be automatically shifted to the compressed air cylinders. It is envisioned, in future embodiments of this patent, those sensors will be incorporated into the pressurized air manifold in such locations and manner sufficient to sense other harmful contaminants, or pollutants, and automatically alarm the user while immediately discontinue the oxygen augmentation system, secure the pressurized air blower and switch to compressed air supply.

FIG. 2 is a back view of an exemplary embodiment of the breathing system 210 with a center air cylinder 212 removed. Cap 206 can be secured to manifold 214 when a cylinder is removed to maintain a closed environment and prevent leakage of air through the cylinder connection 207. Manifold 214 can include various auxiliary components including low pressure alarm 204, high pressure relief disk 205, and low pressure mechanical switch 203. Low pressure alarm 204 can be a mechanical, pneumatic or electronic alarm and can be set at any pressure level to indicate a low pressure level (e.g., system air pressure levels below 1500 psi, 1400 psi, 1300 psi, 1200 psi, 1100 psi, 1000 psi, 900 psi, 800 psi, 700 psi, 600 psi, 500 psi, 400 psi, 300 psi, 200 psi or 100 psi.) Multiple alarm conditions can be set using one or more alarms. Alarms can include audible alarms (e.g. whistles, buzzers, beeps, or chimes), visual alarms (e.g., lights, LEDs, flags, or Barbour pole indicators), or vibratory alarms.

Manifold 214 discharges pressurized compressed air through the discharge port 235 which is connected to an on-off valve 236 high-pressure reducer 237 and low-pressure interface hose 238. The oxygen supply segment of the manifold 264 discharges pressurized oxygen through the discharge port 265 which is connected to an on-off valve 266 high-pressure reducer 267 a low-pressure interface shows 268 and to an operating solenoid 269 located at the bottom of the air manifold. For the low-pressure interface hose 238 can also be connected with high-pressure regulator 251 and high-pressure hose assembly 252, which in turn are connected to high pressure console assembly 255. Low-pressure interface hose 238 is connected to low-pressure air supply is hose 223 and low-pressure second stage demand regulator 227 in embodiment low-pressure air supply hose 223 is helically wound filter air supply hose 224. Solenoid 269 is controlled by proprietary software connected to oxygen Sensor 290. Upon indication of oxygen levels at or below 19%, in the pressurized manifold 242 sensor 290 will send a signal to the proprietary software 691. The Oxygen controller 691 will calculate an appropriate pulsation of oxygen for solenoid 269. That pulse of oxygen will be conveyed by low-pressure hose 293 to the pressurized manifold 242 located just before the inlet to the pressurized air blower 291. The pressurized air blower 218 will discharge enriched oxygen/ambient air mixture to the helically wound filter air hose 224, the engine proceedings through the wound is it you or him to mixing chamber 261 at the breathing zone.

In embodiments, low pressure interface hose 238 can run along or be secured to air filter mounting bracket 241 and high pressure hose assembly 252 can also be secured to air filter mounting bracket 241. Air filter mounting bracket 241 and air filter mounting manifold 242 can provide structural support to the fully assembled breathing apparatus 210. One or more air filters 216 are attached to air filter mounting manifold 242 via air filter connection 217 (not shown). Blower motor 218 also connects to air filter mounting manifold 242. In embodiments, blower motor 218 and air filters 216 can connect to any available connection 217. When a blower motor or air filter is not connected to connection 217, the connection can be secured with a filter connection cap, 219 (not shown) in order to preserve a closed system. It will be appreciated that any number of arrangement of one or more filters with or without the blower motor can be assembled using the filtered air manifold and various air filter connections. For example, three filter cartridges and the blower motor can be connected. Two filter cartridges and the blower motor can be connected. One filter cartridge and the blower motor can be connected. Three filter cartridges can be connected with no blower motor attached. The blower motor can be attached without any filter cartridges.

Filtered air supply hose 224 can connect directly to blower motor 218, which in turn draws air from the filtered air manifold 242. In embodiments of the present invention, the filtered air supply hose 224 can connect directly to the filtered air manifold 242. Filtered air supply hose also connects to the air supply assembly 229 by a barbed hose connection or other standard hose connection. Air supply assembly 229 includes low pressure, second stage demand regulator 227, filtered air supply hose connection 260, and mask connection 261. Mask connection 261 can be a quick connection, such as the NATO standard mask quick connection.

In another example embodiment (not shown), the high pressure console assembly includes a manifold block, a high pressure female quick disconnect, a high pressure male quick disconnect, high pressure hose assembly with swivel connector, and high pressure gauge. The console assembly can include additional pressure connections and/or hose connections for multiple sources of discharge and supply to and from the contained air manifold of the system.

In still another embodiment of the present invention, the pressure cylinders of the system can be refilled or recharged using pressurized air from an external source connected to either the high pressure female quick disconnect or the high pressure male quick disconnect at the X-valve assembly 255. The external source of air can be from the tank of a second breathing apparatus. Indeed, it is contemplated that two or more breathing apparatus can be connected using the high pressure console assembly 255 to accommodate buddy breathing, recharging of spent cylinders, or delivery of medical oxygen as described below. In embodiments of the present invention wherein the use of pure oxygen is contemplated, manifold 214 is constructed from stainless steel. When pure oxygen is not contemplated, manifold 214 can be constructed from stainless steel, titanium, aluminum, brass, composite materials or any other suitable material.

Referencing FIGS. 3 and 3A, the compressed air and oxygen manifold 514 and 564 can be part of a continuous material, such as stainless steel, that is compatible with both oxygen and compressed air at pressures of 6000 psi or may be made from different materials mechanically connected at 590. The purpose of this dual manifold approach would be to provide for a lighter weight manifold conserving additional weight over the unify-manifold approach. One embodiment of the split would be to make the manifold segment 514 out of titanium while retaining manifold segment 515 out-of-state steel. The manifolds identified in FIG. 5A and FIG. 5 are for a two tank manifold system. The cylinder connected to manifold 514 through port 562 would be compressed air cylinders. The cylinder on manifold 564 connected to port 562 would be an oxygen cylinder. Ports 570 are provided for an external jumper 571 to provide for the ability to create a common manifold suitable for use with two compressed air cylinder, if the oxygen augmentation segment were not to be used. This jumper option 571 is only available when a suitable oxygen/compressed air manifold material is employed. The manifold represented in FIG. 3, port 503 is provided to support a pressure sensor monitoring pressure within the compressed air bottles connected to port 562. Port 501 is provided to connect high-pressure line to 352 compressed air shutoff valve to 362 first stage regulator 237 Port 504, located on manifold segment 564, is a pressure sensor to indicate pressure within the oxygen cylinder connected at port 562. Port 503 is provided for the connection to the high pressure hose 265 oxygen shutoff valve 266, first stage oxygen regulator 267 low-pressure hose 268 leading to oxygen control solenoid 269. High-pressure hose 573 is an external jumper provided to connect the two sides of manifold 514 and 515. On manifold 564 located at the end there will be provided and oxygen charging port 530. Compressed gas bottle charging will continue to be accomplished through the proprietary charging system located on air manifold 255

Referencing FIG. 4, depicted are the 2 battery sources for the air blower 662 and the software and oxygen augmentation control system 690. It is envisioned, in other iterations of this embodiment, that the battery system could be a single source or of different voltage depending on the application and the desires of the user. The pressurized air blower system in this embodiment contains two 18 V battery packs 662 feeding a common manifold 660 connected to the blower electrical feed 665 and responding to the manual on-off switch and tether 664. The oxygen augmentation control system 691 is powered by a 9 V battery pack 690. The oxygen augmentation control system 691 receives input from the oxygen sensor are 290 located in the pressurized air filtration manifold 242. This sensor 290 provides a constant monitoring of the inlet gases flowing through the various filter housings 216 mounted on the manifold 242. This oxygen sensor are provides continuous feedback to the oxygen augmentation system. When the oxygen sensor detects a level of ambient oxygen in the manifold below 19% in this embodiment, the oxygen augmentation system will send a signal to the oxygen augmentation solenoid 269 which will pulse a finite addition of pure oxygen into the manifold just prior to the pressurized air blower 218, inlet mounted on the manifold. Future embodiments of this patent may control the oxygen level at any prescribed set point from 13% to 21%. This particular embodiment will rely upon the oxygen augmentation software to properly calculate the quantity and supply of oxygen to supplement (to bring) the manifold ambient oxygen level up to approximately 21%. In future iterations, a secondary oxygen sensor 293 will be provided to form a closed loop system to the oxygen augmented software 691. This feedback loop will guarantee the oxygen level control necessary to maximize the oxygen consumption, thus maximizing system operational time.

In embodiments, the electrical system of the breathing apparatus can be powered by the power supply associated with the blower motor used in the PAPR operational mode. Referencing FIG. 4, electrical connection circuit board 660 is connected to one or more power sources or batteries 662, a releasable on/off switch 664 and the blower mower motor 665. Other electrical devices such as monitors, communications equipment, navigational equipment, and environmental sensors can be connected to the electrical system. In an exemplary embodiment, the electrical system and power supply is dedicated to the blower motor. The battery or power supply can be any standard battery size, and in embodiments supplies electrical power to the blower motor for up to 12 hours or more (e.g., 1-2 hours, 2-3 hours, 3-4 hours, 4-5 hours, 5-6 hours, 6-7 hours, 7-8 hours, 8-9 hours, 9-10 hours, 10 or more hours).

The apparatus itself may include the following parameters, which are adjustable depending on the configuration of the system. The apparatus includes a length of about 18 to 24 inches (e.g., about 19 inches, 20 inches, 21 inches, 22 inches, 23 inches or 24 inches) from top to bottom when placed on a user. The system also includes a width of about 10 to 14 inches (e.g., about 11 inches, 12 inches, or 13 inches). The system may be placed in a backpack to create a depth of about 4 to 8 inches (e.g., about 5 inches, 6 inches or 7 inches) with PAPR and filters, or about 3 to 5 inches without PAPR and filters.

The disclosed system may have a volume of about 1400 to 1600 cubic inches (e.g., about 1450, 1500, or 1550 cubic inches) with PAPR and filters, or a volume of about 900 to 1100 cubic inches (e.g., about 950, 1000, or 1050 cubic inches) without PAPR and filters. These dimensions result in a weight for the system with the backpack of about 20 to 30 pounds (e.g., about 21, 22, 23, 24, 25, 26, 27, 28 or 29) pounds, which is much lighter than conventional respiratory protection systems. The system along with the backpack also may be worn on the front of an operator without significant drawbacks.

These dimensions and weight allow an operator to negotiate tight spaces and crawlspaces or to move about quietly without banging the system against walls and the like. It also allows an operator to use the system for extended periods of time without significant fatigue. Further, an operator may put the system on quickly and without the need for a second party to waist with attaching hoses, filters, and the like. The system also attaches to any face mask with a standard fitting, such as for example a 40 millimeter female thread, as long as a spring-loaded air outlet valve is present.

In embodiment of the present invention, the system includes one or more bottles of self-contained air. The system may use 1, 2 or 3 or more bottles as needed. The bottles or cylinders can have a volume of between about 110 to 130 cubic inches (e.g., about 115, 117, 119, 121, or 123 or more cubic inches). The bottles or cylinders can be any standard pressure vessel. In embodiments, the cylinders can be aluminum, carbon-wrapped cylinders. Example cylinders can include Cobham: 4500 psi Model 6250. Each bottle or cylinder may include about 15 to 25 cubic feet (e.g., about 16, 17, 18, 19, 20, 21, 22, 23, or 24 cubic feet) of compressed air for a total capacity of between about 45 and 75 cubic feet when three bottles are used. Weight of the air at full charge is about 5 pounds. These parameters allow an operator to have about 45 minutes of breathing time at a moderate work rate, such as 40 liters per minute (LPM).

In another embodiment of the disclosed system, a center module slides between the bottles to secure them. The center module also includes attachments for three filters. The filters allow a breathing rate of filtered air of about 64 liters per minute. Two filters are needed to meet standards for respiratory protection and desired filter flow arrangements. The filters are detachable and easily accessible for replacement or maintenance. An operator can arrange the filters on the center module into any desired configuration and is not limited to the configuration shown. For example, an operator may want one filter at the top of the center module for easy access over the shoulder.

The embodiments of the present invention also may include a brushless blower motor that enhances reliability and longevity. The motor can be battery powered. The battery or batteries can provide a duration of about 8 hours or more. A quick-change out battery holder secures the batteries in place. In an embodiment, the disclosed motor uses 5 three-volt batteries, but the preferred embodiments are not limited to this configuration, number or types of batteries, or power settings. Batteries may be designed to be isolated from the breathing system so as to be replaceable in a contaminated environment. In embodiments, the battery or batteries may only feed the motor without supplying other parts of the disclosed system.

The motor can be located on the top of the center module or in line with the filter, as disclosed in FIGS. 6 and 7. Further, the motor may be stand-alone or detachable from the center module, or even movable to any desired location along the center module. Such flexibility allows an operator to keep the motor in a position that is accessible to him in case of emergency or maintenance.

The flexibility with the placement of the filters and the motor (if applicable) permits the operator to maintain a low profile with the disclosed system. The disclosed system may fit into a backpack and not have unwieldy protrusions to knock against fixtures or other items and to fit into smaller spaces than conventional respiratory protection systems. Further, the motor may make noise while in use, and can be located inside the backpack to reduce such noise.

The PAPR system of the disclosed embodiments may be removable from the base system. Thus, the disclosed system may convert to a lower profile or to an air-only system, as depicted in FIG. 7. With the air-only system, the size and weight are reduced for easier use.

The disclosed system also includes regulators to supply the operator with air from the cylinders at ambient pressure. The regulators may configure one or more valves in a series to lower air pressure at each stage. For example, a first stage regulator may reduce the air pressure from about 4500 psi to about 80-150 psi, using one valve for on/off to feed the regulator with the compressed air. In another embodiment, the first stage regulator reduces the air pressure from about 6000 psi to about 80-150 psi. Thus, the first stage regulator converts the pressurized contained air into breathable air. In embodiments the first stage regulator comprises a stainless steel regulator, nickel plated aluminum regulator, titanium or bronze, which is able to withstand high pressures, heat, water and wear/tear associated with hazardous operations.

A second stage regulator also may be included that eliminates or bypasses the filters and feeds low pressure air to the operator. The second stage regulator may be located on the low pressure side of the high pressure reducer. The dual regulator configuration allows the operator to switch the disclosed system between pressurized air supplied from the self-contained air cylinder or pressurized air from an external source and filtered air, either powered or unpowered. Switching between such modes of operation can be done quickly and quietly.

The regulators may incorporate high-performance, lightweight, balance piston or unbalanced piston lung-demand valves. The regulators may deliver in approximately between 500 and 700 (e.g., about 550, 600, 650, or 700) liters per minute of air, thereby supplying all the air necessary to an operator even under the most strenuous working situations. The regulators may be extremely quiet, positive pressure systems that are activated on the first breath. In embodiments, at least one of the regulators may incorporate a demand valve that detects when the operator starts breathing and supplies ambient air.

A donning button permits the regulator to be in stand-by mode for quick activation when needed. An operator may switch to this mode by using the second stage regulator in a quiet manner. Once the operator takes a breath, the regulator leaves stand-by mode and supplies air. The regulator may detect pressure from the PAPR configuration and ceases to free flow the air from the second stage regulator. The second stage regulator pressurizes the mask until it is shut off.

The disclosed regulators also use an ergonomic design that allows an operator to easily connect and disconnect from a mask attached to the disclosed systems. The regulators also may incorporate a check valve acting as an on/off switch. Moreover, the breathing system includes a safety feature that can activate automatically at the occurrence of specified events, such as an operator falling overboard or into water while unconscious or unable to switch between modes, or the obstruction of APR or PAPR air flow.

Charging ports may be located over-the-shoulder or on the waist using a quick-connect male/female connector. The connectors preferably are double-female quick-connect fittings. These may be provided with each system for buddy rescue/charging.

The disclosed systems also may include low pressure alarms to alert the operator when a low pressure condition exists. A pressure sensor connects to a high pressure regulator to alert the operator that an emergency is imminent. The disclosed system may incorporate a variety of alarms. One alarm may be a 70 psi whistle, preferably at about 90 decibels. Alarm whistles can be set at any pressure level depending on the needs of the operator. Another alarm may be an external LED indicator that provides a non-audible alert to the operator. Yet another alarm may vibrate within the mask connected to the disclosed system, straps of the mask, or dedicated neck strap, so that no light or sound is made during an alarm condition. The alarms are coupled to a pressure gauge or sensor that connects to the over-the-shoulder or waist-charging, quick connect fitting. Alternatively, the pressure sensor may be coupled to the high pressure regulator.

In PAPR/APR modes, the inhalation hose attaches between the second stage regulator and the mask. As disclosed in greater detail below, the disclosed embodiments may switch from filter mode to compressed air during emergency situations.

The disclosed system may utilize multiple configurations. The disclosed embodiments, however, are not exclusive to these configurations, and may include additional configurations. These configurations are discussed in greater detail, but the disclosed system is not limited to these configurations, and may be configured in any way available to those skilled in the art. The different configurations may correspond to mission requirements or needs as to respiratory protection.

SCBA Configuration Embodiments

In embodiments of the present invention, the SCBA configuration is the basic configuration format in that it acts as a self-contained breathing apparatus. The SCBA configuration may be the least complex of all the systems. As such, this configuration is intended for confined space operations or limited-duration hostile environment operations.

The SCBA configuration uses one, two or three or more high-pressure cylinders with first and second stage regulators to supply air to an operator. This configuration also uses a pack carry system. The SCBA configuration may not have any PAPR or APR capabilities. The SCBA configuration uses up to three or more cylinders of air, as disclosed above, to provide between 21 and 85 cubic feet of total air. In an embodiment of the present invention, three cylinders of contained air can provide 63 cubic feet of total air at 4500 psi. The system also has an air storage capacity of about 1791 liters at about 4500 psi and air duration of about 45 minutes at 40 lpm. Some embodiments of the present invention include storing the compressed air at about 6000 psi or higher.

As the basic unit, the SCBA configuration does not utilize filters or oxygen (O2) storage for medical or breaching purposes. Cylinders of different gases, however, can be switched out as needed. In embodiments, the SCBA configuration is not limited to only three cylinders of breathable air, but could provide cylinders of different gases, such as welding gases, medical gases, or other industrial gases (e.g., nitrogen, helium, oxygen, acetylene, mixed gases and the like).

The physical parameters of the SCBA configuration are an improvement over the heavy, bulky conventional respiratory protection systems. In exemplary embodiments the SCBA configuration includes a length of about 21 inches and a width of about 12 inches. It also includes a “depth” of about 4 inches such that the disclosed system only protrudes outwards that much, which is well under 6 inches. The SCBA configuration has an air-only weight of about 5 lbs. and a system weight of about 21 lbs. without a backpack and about 23 lbs. with a backpack.

Other embodiments of the SCBA system can include the following features: stand-alone backpack; ballistic plate carrier/pack integration; high pressure blow-out protection; low pressure regulator relief valve protection; CBRNE hardened; filter isolation capability; cylinder recharge capability with quick-connect; low pressure alarm capability; 40 mm PAPR/APR compatibility; decontamination filter and fitting; low pressure auxiliary connection; double-male recharge fitting; and a charging hose (about 6 feet), bleed and gauge arrangement. Some or all of these features may be optional and are not required in the SCBA configuration for operations.

Hybrid Configuration A

The disclosed embodiments can also include a hybrid configuration A (HCA). The HCA configuration combines a maximum use of contained air supply with a PAPR capability to operate in a PAPR mode. The HCA configuration includes the option of operating “un-powered” as an air purifying respirator (APR) mode for extended mission requirements. The HCA configuration also can operate in a supplied air respirator (SAR) mode depending upon available mission support elements. These various modes of operation result in the HCA configuration being the most capable configuration for hostile environment operations.

The HCA configuration uses the three cylinder configuration, as disclosed above with the SCBA configuration. The HCA configuration also includes 1, 2 or 3 filter capability and a positionable blower motor, as disclosed above. In embodiments, the motor is positioned on the top or rear of the system.

The physical parameters for the HCA configuration are compatible to those of the SCBA configuration, except that the HCA configuration weighs slightly more. In an exemplary embodiment, weight without the backpack is about 22 lbs. while the weight with the backpack is about 24 lbs. The HCA configuration also includes all the features of the SCBA configuration along with APR (negative pressure filtration) and PAPR options. The HCA configuration also includes filter isolation capability and a first-breath activated regulator, as disclosed above.

Hybrid Configuration B

The disclosed embodiments also include a hybrid configuration B (HCB) that provides for all four respiratory operational modes of the HCA configuration. The HCB configuration, however, also allows for a lower overall physical profile by removing 1 high pressure cylinder. This difference reduces the available contained air by about 33%. The space formerly reserved for the air cylinder may now be used for storage of all PAPR components inside the carry/back pack. Thus, the filters and motor of the PAPR mode are hidden inside the pack.

The HCB configuration is the lightest of the disclosed configurations and is ideal for missions requiring minimal equipment weight and a short mission time period, or those missions requiring a hidden or reduced physical profile while still providing maximum system versatility. Thus, the HCB configuration uses 1 or 2 air cylinders and 1 or 2 filters. Air storage capacity for the HCB configuration is about 1194 liters and air duration of about 30 minutes at 40 lpm.

The weight for the HCB configuration is lighter than the above-disclosed configuration due to the absence of the third cylinder. Thus, the air-only weight for this configuration is about 3.4 lbs. System weight without the backpack is about 19 lbs. while the weight with the backpack is about 21 lbs. The HCB configuration also includes all the features of the HCA configuration, including the PAPR and APR features.

Hybrid Medical/Breaching Configuration

The disclosed embodiments include a hybrid medical/breaching configuration (HMBC). The HMBC configuration is optimal for specific missions for medical or breaching purposes. It replaces one or more high-pressure oxygen cylinder for one or more of the air cylinders, or is added in addition to one or more of the air cylinders with a high-pressure oxygen cylinder. The oxygen cylinder provides oxygen, or O2, for use in medical operations or as fuel for exothermic cutting apparatus. The HMBC configuration includes the tools and accessories required for both functions. This configuration retains the same respiratory capabilities of the HCB configuration but adds the extra capabilities of the compressed oxygen. The HMBC configuration may be the most versatile of the disclosed configurations.

The parameters of the HMBC configuration resemble the HCB configuration for breathable air, and using PAPR and the like modes. The HMBC configuration, however, also includes a cylinder of compressed oxygen that provides the gas at about 15 lpm for about 30 minutes. The oxygen storage includes about 390 liters at 3000 psi. The HMBC configuration also uses 1, 2 or 3 filters.

The air and oxygen combined weight is about 4.7 lbs. The total system weight without the backpack is about 22 lbs. and about 23 lbs. with the backpack. The other features of the HMBC configuration correspond to those with the HCB configuration.

The breaching option system of the HMBC configuration also may be known as a silent entry torching system (SETS). This option centers on the use of exothermic cutting torch technology and allows an operator to make use of either a conventional rod-style cutting torch or select the use of a cable-style cutting torch. The choice of cutting options is simple due to a user-friendly quick-disconnect. The disclosed system also includes a 12 volt electrical ignition option and also can make use of pyrophoric ignition options as well for either the rod or cable configuration.

The third cylinder configurations also may include one that places a medical oxygen supply cylinder into the disclosed system. This cylinder may be used for medical purposes as opposed to a torch system. Medical operators could deliver O2 or other gases to personnel as needed. In high altitude situations, a different gas mix for this cylinder may be included in case the other cylinders become compromised. In another scenario, at high altitude for example, when the operator drains the two breathing cylinders, but the altitude does not allow for filtered air to be drawn into the disclosed system, this extra cylinder may be accessed.

The above-disclosed configurations and features are modifiable “in the field” by operators using a limited number of tools and with minimal training Changes do not require operators to report back to a depot or maintenance location, but can be done while embedded in a hostile environment. Thus, the disclosed system provides more flexibility than conventional respiratory protection systems.

The disclosed embodiments include the various special features and capabilities across all of its configurations. For example, all configurations automatically switch from PAPR/APR mode to SCBA mode if air flow through the PAPR/APR filters (1, 2 or 3 filter configuration) becomes blocked or flooded. In the filter mode, the inhalation hose attaches between the second stage regulator and the mask. The second stage regulator will not react until the filters become blocked or clogged, thereby engaging a diaphragm with pressure that switches over to compressed air for breathing.

An example of this situation is where the disclosed system becomes partially or totally submerged in water during maritime operations. This feature ensures continued air flow to the operator should he fall overboard, through a hole, a room floods, or the like. The disclosed system also provides an operator with positive buoyancy should the operator be forced to enter a water environment. This feature enables the disclosed system to serve as a secondary personal flotation device.

The disclosed embodiments support a low physical profile, which makes them ideal for confined space rescue operations. The operational versatility and durability also makes the disclosed system advantageous for Special Forces and para-rescue operations or tactical law enforcement operations. The carry-pack system is adaptable to interconnect and operate in association with several makes and models of personal tactical armor systems. In embodiments, the disclosed system can adapt to those personal protection units already in place, and does not require a large retrofit of existing equipment.

Even with the backpack or carry pack option, the disclosed system can be front-mounted, or placed in front of the operator. This feature allows for use in military parachute operations. An operator can move the pack to his/her front when needed. While back-mounted, the disclosed system allows an operator to drive, sit in, or use equipment in a ground or airborne vehicle and access breathable air. One may do this without major discomfort or having to lean forward. Thus, continuous breathable air is provided while in the middle of operations on such vehicles.

Oxygen Augmentation Configuration:

In another example embodiment a hybrid oxygen augmentation powered air purifying respirator apparatus or OAPAPR is provided. In this embodiment, ambient air quality is continuously monitored, and in particular, oxygen levels in the ambient air are continuously monitored. When oxygen levels are below acceptable levels, but the ambient air is otherwise free of contaminants, or contains contaminants that can be filtered, the OAPAPR system augments the ambient air with an Oxygen mix from a dedicated oxygen augmentation cylinder (tank) to bring the Oxygen level in the air delivered to the operator back to 21%. The ability of this system to inject pure oxygen or oxygen enriched air into the pressurized air manifold supplementing ambient oxygen levels found within a confined space, while simultaneously removing from that ambient air stream, through specialized air filters, all designated contaminates, coupled with an emergency compressed air system suitable for evacuation provides a flexible and safe system having giving the operator the ability to extend time in the space without depleting compressed air for egress or evacuation. Now individuals will be able to enter “low oxygen or contaminated spaces and remain for extended periods of time, without utilizing their emergency supply of compressed air.

Control circuitry and software are necessary to provide continuous monitoring and operation of the solenoid valves to deliver the proper mix of oxygen to the user. In an example embodiment of the present invention operation and control of the oxygen augmentation configuration may include the following features and operation. A power on switch initiates a self-diagnostic test within the system. Upon completion of the self-diagnostic, determining that all systems are operating, the blower will commence running on the PAPR system. The electronic control system will monitor air flow from the PAPR blower establishing whether or not the unit is actually outputting air pressure. If the blower is receiving a signal to operate but is not creating sufficient air flow within the manifold an alarm will be indicated to the operator and oxygen augmentation logic will be disabled. If air flow is established the electronic control system will then verify that the compressed air tank pressure sensor and the Oxygen bottle pressure sensor has a predetermined amount of pressure in the tank/tanks. If either the air or oxygen tank pressure sensor senses low-pressure within the tank an alarm would be sounded. If there is suitable pressure within the tanks the electronic control system will then verify the level of oxygen present within the ambient air through an oxygen analyzer. If the oxygen level within the ambient air stream, within the manifold, is less than a predetermined amount, for these purposes approximately 18% but it may be higher or lower depending on the requirements of the system, the oxygen augmentation logic within the control system will be notified. If the oxygen percentage identified by the sensor 806 determines that there is sufficient air to support the wearer, for the sake of this discussion we will establish that at 21% but it could be higher or lower depending on the design of the equipment and the needs of the user, the control logic will repeat the loop back in order to continuously monitor the state of the ambient environment and the operation of the system. If the oxygen level is not acceptable the electronic control system, operating the “oxygen augmentation logic” will calculate the amounts of oxygen necessary to be added to the manifold sufficient to reestablish a proper level of oxygen within the air stream going to the user. When oxygen is being added to the system an alarm will be indicated and a solenoid will be opened which will supplement the air within the manifold with pure oxygen and return the logic system to continue the loop analysis assuring continuous maintenance of proper oxygen levels to the user. If the electronic control system senses that it is unable to maintain the established oxygen level within the manifold, suitable air flow or in unacceptable contaminant the system will be shut down and the user will be transferred over to the high pressure compressed air gas system automatically.

An example blower logic control process 100 is shown in FIG. 8 (references numbers referred to in FIG. 8 are unique to FIG. 8). Process 100 is initiated upon the start of the blower and the logic controller (block 102). As an example, process 100 begins when the device is powered on via its power switch.

Upon initiation of process 100, the logic controller performs one or more pre-test checks (block 104). These pre-test checks act as a self-diagnostic test, and determine whether the device is operating correctly before use and continuously during the operation of the unit.

The device can perform a variety self-diagnostic tests and/or checks in order to assess the operating condition and ongoing status of one or more of its components. It is recognized that all checks are part of a parallel system authorization program, where all pre checks are done simultaneously and form the authorization criteria to move forward with air sampling and oxygen augmentation. For example, the logic controller will determine if the blower is powered, and if the blower is inducing air flow (block 106). This determination can be made, for example, using appropriate sensor modules that detect the power state of the blower and/or air pressure or flow from the outlet of the blower. If the logic controller determines that the blower is powered and producing airflow, the logic controller proceeds, pending the results of other pre-test checks. If the logic controller determines that the blower is not powered or that it is not inducing air flow, an alarm is triggered (block 108), informing the user of the abnormality (system auto switches to compress gas mechanically). Thus, if the blower is not functioning correctly, the user will be informed of the malfunction before or while he uses the device.

Additionally, the logic controller will determine if the air pressure in the oxygen augmentation cylinder (OAC) is equal to or greater than a particular set point (block 110). This set point can be a pre-determined value, for example a pre-determined pressure threshold corresponding to a particular amount of oxygen or reserve time projection. If the logic controller determines that the OAC pressure is equal to or greater than the set point, the logic controller proceeds, pending the results of other pre-test checks. If the OAC pressure is less than the set point, the OAC pressure measurement is repeated to verify the previous measurement (block 112) (the system will inquire as to the ambient oxygen level with the space/manifold, plus sound an alarm 114 informing the user of the abnormality. If the OAC is below the preset level and the ambient oxygen level within the monitoring zone is less than a predetermined safe operating environment the system will shut down the blower, forcing and automatic transition to the compressed air source. If the ambient air is safe than the controller will still sound an alarm indicating low OAC 114, but will sustain the blower and begin the operational checks. (circle 3). If the OAC is equal to or greater than the set point If the OAC pressure is equal to or greater than the set point, the oxygen augmentation solenoid is adjusted (block 116) in order to adjust the amount of supplemental oxygen delivered from the OAC, the air blower is secured, and the air supply is switched to the compressed air supply (block 118). Thus, if the OAC is unable to provide a particular amount of supplemental oxygen, the user will be informed of the condition before he uses the device.

Additionally, the logic controller will determine if the air pressure in the air cylinder (i.e., the compressed air supply) is equal to or greater than a particular set point (block 120). pending the results of other pre-test checks. The logic controller also checks the OAC This set point can be a pre-determined value, for example a pre-determined pressure threshold corresponding to a particular amount of air. If the air cylinder pressure is less than the set point, an alarm is triggered (block 122), informing the user of the abnormality If the air cylinder pressure is equal to or greater than the set point, the logic controller proceeds, pressure (block 112), and as described above, either triggers an alarm (block 114) (if the OAC is below the set point) or secures the air blocker and switches to compressed air supply (block 118) (if the OAC is equal to or greater than the set point). Thus, if the air cylinder is unable to provide a particular amount of air, the user will be informed of the condition before he uses the device. Further, if the air cylinder is able to provide a particular amount of compressed air, but the OAC is unable to provide a particular amount of supplemental oxygen, the user will be informed of the condition and the device will switch to the compressed air supply, such that the user no longer relies on the OAC for supplemental oxygen.

An additional check is the logic controller can determine if the battery level of the device is equal to or greater than a particular set point (block 124). This set point can be a pre-determined value, for example a pre-determined voltage corresponding to a particular amount of power remaining in the battery. If the logic controller determines that the battery level is equal to or greater than the set point, the logic controller proceeds, pending the results of other pre-test checks. If the battery level is less than the set point, an alarm is triggered (block 126), informing the user of the abnormality, (remove “the air blower is secured”), and the user than has the option of continuing to utilize the blower or shut it down and automatically switch to the compressed air supply (block 118). Thus, if the battery is reaching a point where there is insufficient power to the device, the user will be informed of the condition and the user will make a decision whether to remain on the blower and ambient air or switch to the compressed air supply and the user no longer relies on the OAC for supplemental oxygen.

The last of the pretest checks by the logic controller in this embodiment is to determine if a poison is present in the ambient air within the manifold (block 128). This determination can be made, for example, using appropriate sensor modules that detect a presence of poison in the filtered air manifold. If the logic controller determines that a poison is not present, the logic controller proceeds to complete the pre-test and operational checks allowing the system to begin the oxygen augmentation evaluation. If the logic controller determines that a poison is present, an alarm is triggered (block 129), informing the user of the hazardous condition, the air blower is secured, and the air supply is switched to the compressed air supply (block 118). Thus, if a poison is present in the filtered manifold air supply, the user will be informed of the condition, and the device will switch to the compressed air supply, such that the user no longer relies on the ambient air for oxygen, but is automatically transitioned over to the compressed air supply through the mechanical switching valve located at the 2^{nd} stage of the regulator.

It should be noted, that each of the pre-test blocks has an associated circuit continuity loop (designated by **). These circuit loops are provided as continuity locks around a fault if one is determined by the testing system. These loops are necessary in order for the Logic Controller (block 104) to continually monitor all of the aspects of the system, even if a fault has been determined. If for example, the OAC (block 110) sensor were to determine, after the system is being used, that the pressure is less than the established set point, however the oxygen level monitored within the filtered air manifold were greater than the point, at which oxygen augmentation would be required. In this scenario, the Logic Controller would provide the alarm of low OAC pressure (block 114). Given this particular situation, the Logic Controller would have the system continue functioning entirely in order not to deprive the user of valuable input from the other sensors. Even in the case of a positive poison gas sensor reading (block 128), the Logic Controller would continue to sustain the ongoing process of checking the status of all the other systems.

Upon initial use and during the subsequent checks during utilization, if the Logic Controller determines that all of the pre-test checks have been successfully passed, the logic controller analyzes the oxygen sensors and determines the level of oxygen augmentation required for the ambient air (block 130). In an example, the logic controller analyzes measurements obtained from the ambient oxygen sensor in order to determine the ambient oxygen level (block 132), and the blower outlet oxygen sensor in order to determine the oxygen level output by the blower from the OAC (block 134). The logic controller then compares the ambient oxygen level to a particular set point or range (132). If the ambient oxygen level is equal to the set point or within the range (for example a set point of 21% oxygen, or between 19-23% oxygen) (block 134) and no poison gas is detected within the filtered air manifold, no oxygen augmentation is required, and the logic controller begins the process (100) again of continuously monitoring the condition of the device and the ambient environment.

If the ambient oxygen level is less than the set point or range (block 136), the oxygen augmentation solenoid is adjusted (block 116) in order to increase the amount of supplemental oxygen delivered from the OAC. If the ambient oxygen level is greater than the set point or range (block 138), the oxygen augmentation solenoid is adjusted (block 116) in order to decrease the amount of supplemental oxygen delivered from the OAC. The solenoid can be adjusted based on a measurement of the oxygen level supplied by the blower from the OAC in order to provide the desired amount of supplemental oxygen. The logic controller then begins the process (100) again in order to continuously monitor the condition of the device and the ambient environment. The exception to the above sequence occurs when oxygen levels detected are less than the predetermined amount (block 136) and are considered unsafe and an alarm of low OAC pressure (block 110) have been determined simultaneously. Under this set of conditions along with the low OAC pressure alarm (block 114) sounding, the Logic Controller will shut down the blower supplying air from the filtered air manifold. At this point the system will automatically transitioned to the compressed air cylinder.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, logic sequence or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, the disclosed embodiments provide a respiratory protection breathing system and associated device to allow more flexibility, lighter weight, adaptability, low maintenance and a more durable product to the operator in hostile environments.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A breathing apparatus comprising:
one or more contained air cylinders connected to a supply manifold:
one or more oxygen augmentation cylinders connected to the supply manifold;
a first supply hose;
one of more filters connected to a filter air manifold;
a filtered air/oxygen augmented supply hose connected to the filtered air manifold;
a compressed air supply hose connected to both the contained air supply hose and the filtered air supply hose for delivery of pressurized contained air, filtered air, powered filtered air or Oxygen augmented air.

2. The breathing apparatus of claim 1 wherein the pressurized compressed air is supplied on demand if the filtered/oxygen augmented air supply is reduced.

3. The breathing apparatus of claim 1 further comprising a regulator connected to the contained air and oxygen augmentation supply sources.

4. The breathing apparatus of claim 3 further comprising two high-pressure regulators in communication with the supply manifold.

5. The breathing apparatus of claim 2 further comprising 2 high-pressure assemblies comprising a high pressure input connection and a high pressure output connection where in the high-pressure assemblies are in communication with the supply manifold.

6. The breathing apparatus of claim 1 wherein self-contained air is supplied to a 2nd air supply assembly through the high-pressure assembly.

7. The breathing apparatus of claim 1 wherein oxygen augmentation is supplied to the pressurized air manifold.

8. The breathing apparatus of claim 1, wherein the contained air cylinders are charged with high-pressure air through the high-pressure assembly.

9. The breathing apparatus of claim 1 wherein the contained oxygen cylinder are charged through a high pressure port located in the manifold adjacent to the oxygen cylinder.

10. The breathing apparatus of claim 1 wherein the air supply assembly is a sealable mask.

11. The breathing apparatus of claim 1 wherein at least one of the cylinders contains oxygen and at least one cylinder contains compressed air.

12. A modular breathing apparatus comprising;
a self-contained air module comprising;
one or more pressurized cylinders,
a pressurized air supply hose, and
a manifold connected to one or more cylinders and the pressurized air supply hose;
a filtered air module comprising;
one or more air filtration cartridges,
a filtered air supply hose,
a filtered air manifold connected to the one or more filtration cartridge, and
a filtered air supply hose a powered air module comprising a blower motor connected to a filter air supply;
an oxygen augmented assembly comprising,
one or more compressed oxygen augmentation cylinders connected to a manifold,
a regulated solenoid valve feeding the filter manifold prior to the pressurized blower,
a pressurized air supply hose, and
an Electronic Logic Control module;
and an air supply assembly for delivery of pressurized air in filtered air to a user comprising a regulator connected to the pressurized air supply hose and a filter air supply connection.

13. A breathing apparatus comprising:
a continuous oxygen sensor;
an oxygen supply; and
control logic for delivering oxygen from the oxygen supply in sufficient quantity to provide breathable air to a user having an oxygen concentration of 20% to 22% oxygen.

14. The breathing apparatus of claim 13 further comprising a blower and filter system for delivering pressurized air to a user.

15. The breathing apparatus of claim 14 wherein the oxygen is supplied to air received from the blower and filter system.

16. The breathing apparatus of claim 13 further comprising a compressed air supply.

17. The breathing apparatus of claim 16 wherein the control logic causes compressed air to be delivered to the user when the oxygen supply falls below a preset level.

18. A method of controlling a breathing apparatus comprising:
continuously monitoring oxygen levels in air supplied to a user;
causing oxygen or oxygen enriched air from an oxygen supply to be delivered to air supplied to a user when the monitored oxygen levels fall below a predetermined value;
monitoring the supply level of oxygen or oxygen enriched air; and
causing compressed air to be delivered to a user when the supply level of oxygen or oxygen enriched air falls below a predetermined level.

19. The method of claim 18 wherein the air supplied to a user is ambient air from a blower and filtration system.

20. The method of claim 19 wherein oxygen levels are monitored in the ambient air and in the air delivered from the blower and filtration system.
